(19) United States
(12) Patent Application Publication
(10) Pub. No.: US 2018/0063128 A1
(43) Pub. Date: Mar. 1, 2018

(54) METHOD FOR AUTOMATICALLY DELETING A USER PASSWORD UPON SUCCESSFUL USE OF A MULTI-FACTOR AUTHENTICATION MODALITY

(71) Applicant: MOTOROLA SOLUTIONS, INC, CHICAGO, IL (US)

(72) Inventors: MICHAEL F. KORUS, EDEN PRAIRIE, MN (US); IRINA KLEYMAN, WHEELING, IL (US); ADAM C. LEWIS, BUFFALO GROVE, IL (US)

(21) Appl. No.: 15/252,818

(22) Filed: Aug. 31, 2016

(51) Int. Cl. H04L 29/06

(52) U.S. Cl. CPC H04L 63/0846; H04L 63/10

(57) ABSTRACT

A method is provided for automatically deleting user passwords. Upon receiving a password-less user authentication a password grace period timer is started. Upon expiration of the password grace period timer the password is deleted if a user confidence score associated with the user is greater than a confidence threshold.

### BACKGROUND OF THE INVENTION

Security and access control are two of the fundamental needs for any computer system. These needs are even more pronounced in public safety systems.

One common security method is passwords, which are nearly ubiquitous. However, passwords have several downsides. A first is that passwords can be guessed, often using common numbers associated with a user, such as birthdays, anniversaries, etc.

A second problem with passwords is that systems often require users to frequently change their passwords, to prevent a nefarious user from having continued unauthorized access to their system. Unfortunately, with the proliferation of passwords and the frequent requirement to change them, users often resort to password conventions or simply write their passwords down. This actually decreases system security.

Other forms of access control have been utilized, such as smart cards, security tokens, and biometric authentication. Unfortunately, these other forms of access control also have drawbacks, such as theft or loss of cards or tokens and difficulty in learning to use biometric authentication. The learning curve for biometric authentication can also lead to frustration.

Therefore a need exists for a method and apparatus that provides enhanced access control while providing adequate usability, especially within public safety networks. In addition, there is a need to get users to utilize newer more secure authentication modalities without frustrating the user or denying the user access to the system during the transition to new authentication modalities.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a network in accordance with an exemplary embodiment of the present invention.

FIG. 2 depicts a flowchart of a method for performing multifactor authentication in accordance with an exemplary embodiment of the present invention.

FIG. 3 depicts a flowchart of a method for determining if a password should be deleted from a database in accordance with an exemplary embodiment of the present invention.

FIG. 4 depicts a flowchart of a method for adjusting the Population False Rejection Rate (FRR) in accordance with an exemplary embodiment of the present invention.

FIG. 5 depicts a flowchart of a method for adjusting confidence thresholds utilizing machine learning in accordance with an exemplary embodiment of the present invention.

FIG. 6 depicts a flowchart of a method for calculating a user authentication confidence score in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method for automatically deleting user passwords upon successful use of a multifactor authentication modality. When a user enrolls one or more multi-factor authentication modalities with a system in place of a single-factor password, the system will be more secure once the single-factor password is deleted. The multi-factor authentication modalities include knowledge (such as a password or PIN), possession (such as a token), and inherence (such as biometric information including retina scans, iris scans, fingerprint scans, finger vein scans, facial recognition, voice recognition, and hand geometry). If the password is deleted before the user is able to effectively use multi-factor authentication, the user will be frustrated and may be locked out of the system. If the password is never deleted or is deleted after a very long while, system security may be compromised.

In accordance with an exemplary embodiment of the present invention, the use of analytics, such as machine learning or security analytics, is used in making a decision on whether a user's password can be auto-deleted. More particularly, analytics are used to evaluate user authentication confidence for determining when to delete a user's password. Upon receiving a successful password-less user authentication, a password grace period timer is started. A user confidence score is calculated for the user and is updated with information regarding false rejections and failed user verifications. A false rejection, also known as a type I error, is a mistake made by an inherence authentication system when falsely rejecting an authentic user.

Upon expiration of the password grace period timer, a password associated with the user is automatically deleted if the user confidence score is greater than a confidence threshold.

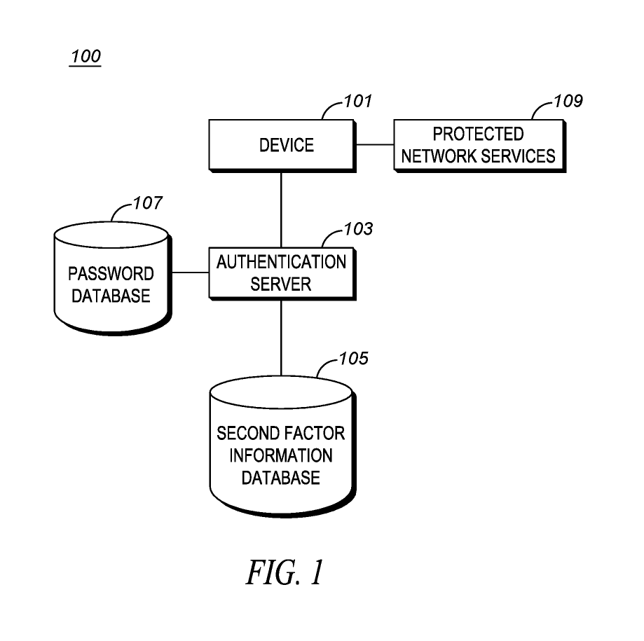

FIG. 1 is a system diagram illustrating a network 100 in accordance with an exemplary embodiment of the present invention. Network 100 includes a device 101, an Authentication Server 103, a Second Factor Information Database 105, a password database 107, and a Protected Network Services server 109.

Device 101 is a user's computing device, such as a mobile phone, that can communicate with Authentication Server 103 and is capable of using authentication services.

Authentication Server 103 is a server that is used to authenticate the user credentials to prove the user owns his/her identity. The credentials can be, for example, user identities and passwords or other forms of authentication, such as public key cryptography, out-of-band passcodes, tokens, and biometric data. Authentication Server 103 is coupled to Device 101 and Database 105. Authentication Server 103 preferably resides on a dedicated computer. Authentication Server 103, upon verifying the presented credentials, provides access to various services or networks (109).

Second Factor Information Database 105 is a storage device for storing information and data. In an exemplary embodiment, Second Factor Information Database 105 stores user confidence scores, user FRRs, user FUVs, and population FRRs, preferably per modality. In a second exemplary embodiment, the user confidence scores, user FRRs, user FUVs, and population FRRs (per modality) are each stored in their own databases, although only one database is shown for simplicity.

Password Database 107 stores passwords. In accordance with an exemplary embodiment, once a user has successfully learned how to use multifactor authentication the passwords are deleted from Password Database 107.

Protected Network Services server 109 comprises the network services the user is attempting to access. If a user wants to access some service on the network, Protected Network Services server 109 requires proof that the user owns the identity that they presented to the system. Protected Network Services server 109 redirects the user to Authentication Server 103 to authenticate the user. This is where a user would enter a user name and password or would perform multifactor authentication. Upon completion of user authentication, Authentication Server 103 redirects the user back to the protected network service. In an exemplary embodiment, the redirection includes a secondary authentication credential, for example a cookie, token or assertion, which informs the protected service of the successful user authentication. The user now has access to data the user is authorized to access, based on the user's authenticated identity.

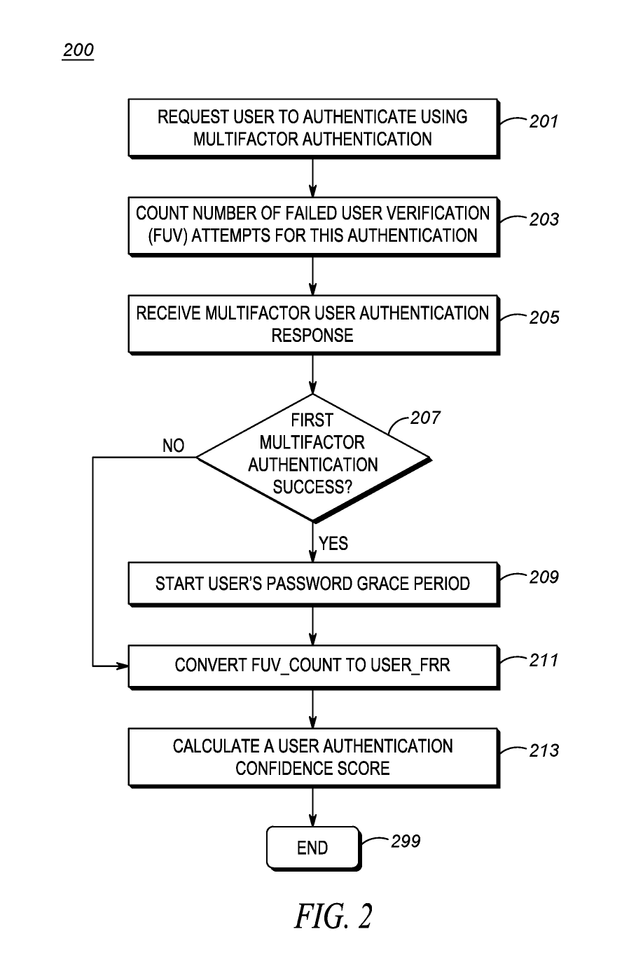

FIG. 2 depicts a flowchart 200 of a method for performing multifactor authentication in accordance with an exemplary embodiment of the present invention. In this exemplary embodiment, a user of device 101 is transitioning to multifactor authentication in order to provide enhanced security for device 101. When a user first successfully authenticates using a multifactor authentication method, a grace period timer is started in order to give the user a predetermined time period to have the ability to use a phased-out authentication method, such as a password. Statistics are kept of failed authentication attempts using the multifactor authentication method. If the grace period timer expires and the user has not mastered the multifactor authentication technique as determined using their confidence score, the timer is extended and the user is flagged and preferably signed up for user training for the new multifactor authentication technique.

The process starts when device 101 requests (201) a user of device 101 to authenticate themselves using multifactor authentication, for example per FIDO Alliance's Universal Authentication Framework 1.0. In this exemplary embodiment, access to protected network services 109 is being moved from a password-based authentication method to a multifactor authentication. Authentication Server 103 is updated to support multifactor authentication, for example, the FIDO Alliance Universal Authentication Framework 1.0 specifications. In an exemplary embodiment, the authentication request is for a multifactor authentication, such as a PIN plus public key or a biometric scan plus a public key. A password can be used as a backup form of authentication until the password service is no longer offered.

Device 101 receives an authentication attempt from the user. If the authentication attempt is a multifactor authentication attempt, device 101 counts (203) the number of Failed User Verification (FUV) attempts of the multifactor authentication. For example, device 101 counts how many times the user had to submit a biometric sample, whether eventually succeeding or failing at user verification. By tracking all failed user verifications, a more accurate confidence score can be calculated.

Device 101 sends and Authentication Server 103 receives (205) a Multifactor User Authentication Response from device 101. The Multifactor User Authentication Response preferably includes the number of FUV attempts counted at step 203. In a second exemplary embodiment, device 101 reports the number of FUV attempts independent of authentication. For example, device 101 can send a daily update of the number of total user verification attempts versus the number of successful attempts.

Authentication Server 103 determines (207) if the user was successful with the multifactor authentication. In an exemplary embodiment, if the user was successful with the multifactor authentication and this is the first successful multifactor authentication request, Authentication Server 103 starts (209) a grace period timer. The grace period timer establishes a period of time in which a user's password will be maintained. However, during this time the system determines a confidence score which may result in an extension of the grace period. The grace period timer is established to allow for an evaluation of the system's confidence in the user's ability to successfully authenticate using a new authentication modality. When at least one of the modalities is learned within the grace period the password is deleted. In accordance with an exemplary embodiment, the password grace period is fourteen days, although any length of time that is adequate for a user to become proficient with a new authentication modality could be chosen. If an organization shares devices among its users, the password grace period may be longer than for non-shared devices, and may be different for distinct users of the shared device.

Whether this was the first multifactor authentication success or not, as determined at step 207, Authentication Server 103 converts (211) the FUV count to a false rejection rate for the user. Authentication Server 103 copies the User FRR to a User FRR database.

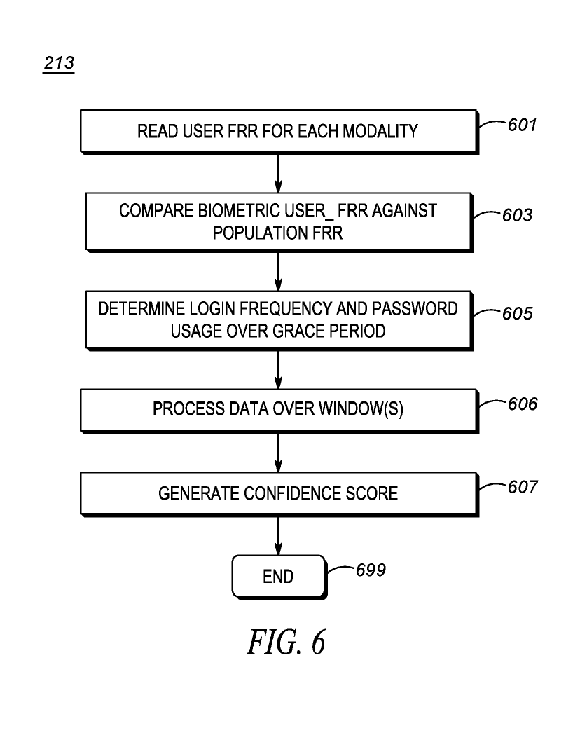

Authentication Server 103 calculates (213) a User Authentication Confidence Score, as depicted in more detail in FIG. 6. In accordance with an exemplary embodiment, this calculation occurs when the grace period expires. In an alternate exemplary embodiment, this calculation occurs during user authentication. The process then ends (299).

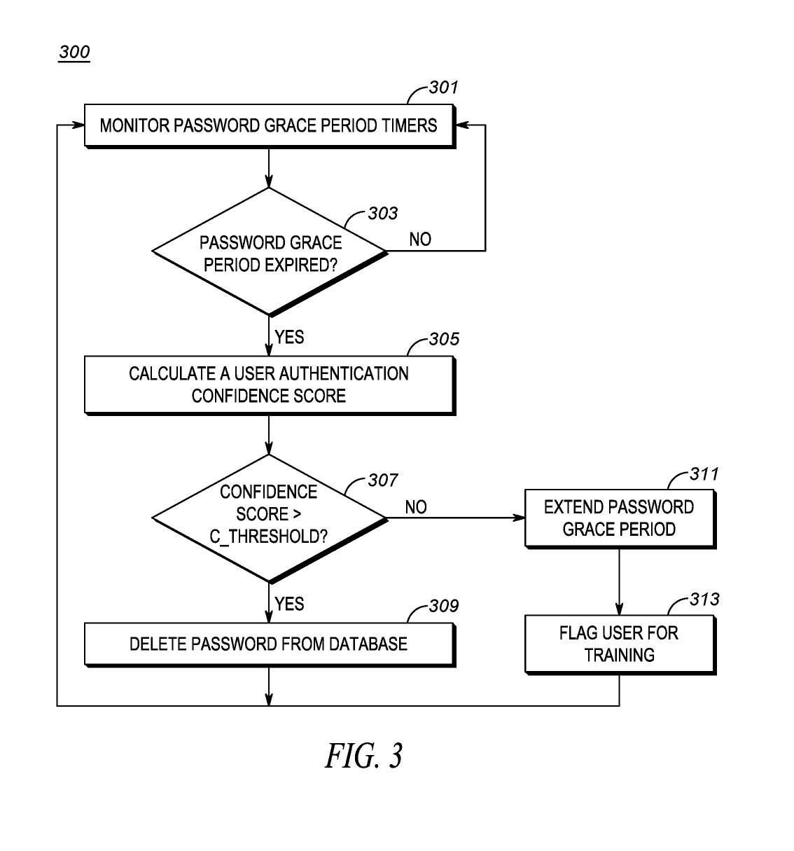

FIG. 3 depicts a flowchart 300 of a method for determining if a password should be deleted from a database in accordance with an exemplary embodiment of the present invention. In this exemplary embodiment, analytics is used to evaluate a confidence score in a user's mastery of biometric authentication.

Authentication Server 103 monitors (301) a password grace period timer. The grace period timer is preferably started the first time a user successfully authenticates using a non-password authentication technique.

Authentication Server 103 determines (303) if a password grace period timer has expired. If no password grace period timer has expired, Authentication Server 103 returns to step 301.

If Authentication Server 103 determines that a password grace period timer has expired at step 303, this indicates that the user should have had sufficient time to master the multifactor authentication and Authentication Server 103 continues with the remaining steps of FIG. 3.

Authentication Server 103 calculates (305) a User Authentication Confidence Score, as depicted in more detail in FIG. 6. The User Authentication Confidence Score is an indication of how well the user has mastered the multifactor authentication technique.

Authentication Server 103 determines (307) if the User Authentication Confidence Score is greater that a Confidence Score Threshold. This determination will determine if the user is prepared to have their password deleted or if they need more time to effectively use the multifactor authentication and perhaps need additional training.

If Authentication Server 103 determines that the User Authentication Confidence Score is greater than the Confidence Score Threshold, this indicates that the user has learned how to use the multifactor authentication procedure, such as a biometric scan. Since the user has mastered the multifactor authentication technique, Authentication Server 103 deletes (309) the password from database 105. By eliminating the ability to access the system with just a password, security for the user of device 101 has been improved.

If Authentication Server 103 determines at step 307 that the User Authentication Confidence Score is not greater than the Confidence Score Threshold, this indicates that the user has not learned how to effectively use the multifactor authentication procedure. Therefore Authentication Server 103 extends (311) the Password Grace Period so that the user has more time to learn how to use the multifactor authentication technique and can still access device 101 using a password or the like. The password grace period extension could be the same as the original timer period, or could be any length of time that provides sufficient access to the system while the user learns the new multifactor authentication method.

Since the user is not able to effectively use the enhanced authentication procedure, Authentication Server 103 flags (313) the user for training in using the enhanced authentication procedure.

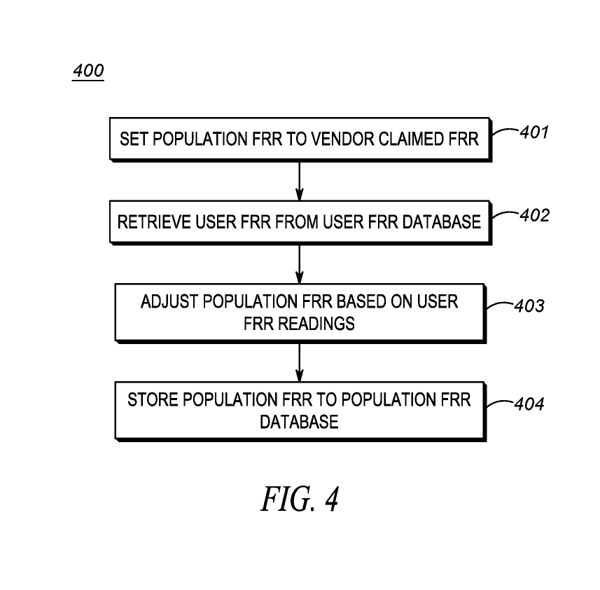

FIG. 4 depicts a flowchart 400 of a method for adjusting the Population False Rejection Rate (FRR) in accordance with an exemplary embodiment of the present invention. The Population FRR is the false rejection rate of a population of users that includes the current user. For example, the Population FRR could be for all employees who work at the user's company. This gives a benchmark to assist in telling how well the user is doing in learning and effectively utilizing the new multifactor authentication compared to the user's peers. Each Population FRR is preferably associated with a specific authentication modality.

The Population FRR is set (401) to a predetermined value. In accordance with an exemplary embodiment, the Population FRR is set to a first value that the biometric vendor recommends based on its testing. This initial FRR will continually be updated with actual FRR values and so will adjust over time. Based upon the vendors FRR calculation techniques and the FUV based FRR calculation techniques, normalization may be required to compute the initial Population FRR.

Authentication Server 103 retrieves (402) a User FRR from a User FRR database. The User FRR retrieval can be done at predetermined time intervals. In a further exemplary embodiment, the User FRR retrieval can be done whenever an administrator or the like wants to determine a new Population FRR. In a further exemplary embodiment, the User FRR retrieval can be done upon a predetermined number of entries in the User FRR database. The retrieval can be a retrieval of an individual user's FRRs or multiple users' FRRs.

Authentication Server 103 adjusts (403) the Population FRR based on user FRR readings. In a first exemplary embodiment, the Population FRR is calculated by a weighted average of all the user FRRs, where the weighting is a function of quantity of user authentication attempts.

Authentication Server 103 stores (404) the newly calculated Population FRR in a Population FRR database.

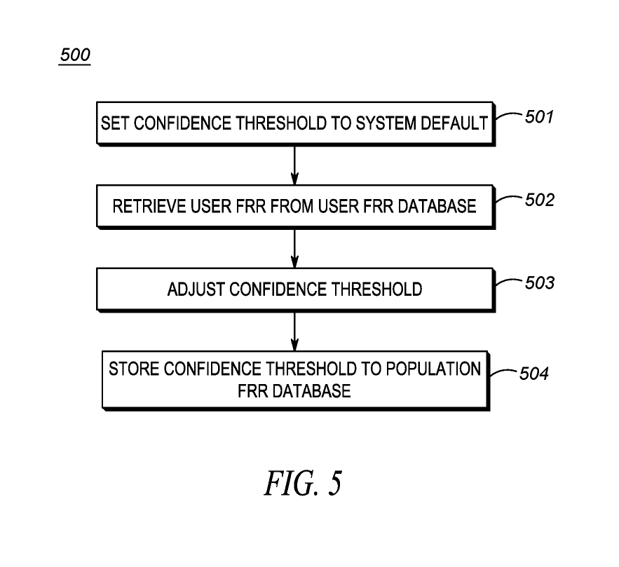

FIG. 5 depicts a flowchart 500 of a method for adjusting confidence thresholds utilizing machine learning in accordance with an exemplary embodiment of the present invention. The confidence threshold is a value that sets the minimum value at which an administrator would be confident that a user has achieved proficiency in using a new multifactor authentication modality. In an exemplary embodiment, a confidence threshold is set for each authentication modality.

A Confidence Threshold is initially set (501) to a predetermined value. This initial Confidence Threshold will continually be updated and so will adjust over time.

Authentication Server 103 retrieves (502) a User FRR from a User FRR database. The User FRR retrieval can be done at predetermined time intervals. In a further exemplary embodiment, the User FRR retrieval can be done whenever an administrator or the like wants to determine a new Confidence Threshold. In a further exemplary embodiment, the User FRR retrieval can be done upon a predetermined number of entries in the User FRR database. The retrieval can be a retrieval of an individual user's FRRs or multiple users' FRRs.

Authentication Server 103 adjusts (503) the Confidence Threshold based on user FRR readings. In typical systems, the Confidence Threshold does not change frequently. In a first exemplary embodiment, the Confidence Threshold is calculated by combining a comparison of the False Rejection Rate, the new multifactor usage, and the password usage. For example, the comparison of the False Rejection Rate compares the total number of user false rejections in the grace period to calculate a False Rejection Rate for the grace period and compares it to the populations False Rejection rate. The New Multifactor Usage and the Password usage are preferably averaged throughout the grace period. More exhaustive analytics can be performed, for example analyzing the user's behavior over different windows of time, different locations, different assignments, or different weather conditions. The purpose would be to look for trends. These analytics would be used to adjust the confidence score.

Authentication Server 103 stores (404) the newly calculated Confidence Threshold.

FIG. 6 depicts a flowchart 213 of a method for calculating a user authentication confidence score in accordance with an exemplary embodiment of the present invention.

Device 101 reads (601) a user's FRR for each modality.

Authentication Server 103 compares (603) the FRR for the user with the Population FRR. In an exemplary embodiment, this comparison is done for each authentication modality. The Population FRR is preferably initially set to a default and is continuously updated for a targeted population. The population can be an agency, a subgroup within an agency, or a user group.

Authentication Server 103 determines (605) a login frequency and password usage over grace period. A confidence score considers the frequency of login attempts using the new authentication modality. This helps to detect cases such as users establishing a multifactor authentication modality prior to vacation or an infrequent user. The frequency rate is measured over a period of time. If a user continues using their password after having authenticated with a new authentication modality, this password usage is factored into the confidence score. In an exemplary embodiment, if a user enters their password during the grace period, the grace period is extended. This preferably depends upon how often the password is used during the grace period.

Authentication Server 103 processes (606) data over at least one window of time within the grace period to calculate a confidence score of the user. In one exemplary embodiment, data analytics are performed over the entire grace period window to determine a confidence score. In another exemplary embodiment, data analytics are performed over multiple windows of time, for example, daily windows of time or weekly windows of time or any other period of time as deemed necessary to determine a confidence score. When data analytics are performed over multiple windows of time within the grace period, weighting is applied to the individual window analysis. This provides the ability to determine the relative importance of the individual confidence calculations, for example a higher weighting for the most recent window calculations.

Authentication Server 103 generates (607) a confidence score, preferably by calculating a confidence score over the grace period. In an alternate exemplary embodiment, Authentication Server 103 generates a confidence score by calculating a weighted average confidence score over the multiple windows of analysis. The process then ends (699).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for automatically deleting user passwords, the method comprising:
receiving a successful password-less user authentication;
starting a password grace period timer; and
upon expiration of the password grace period timer, deleting the user password if a user confidence score associated with the user is greater than a confidence threshold.

2. The method of claim 1, the method further comprising extending the password grace period timer if the user confidence score is less than the confidence threshold.

3. The method of claim 1, the method further comprising flagging the user for training in using multi-factor authentication if the user confidence score is less than the confidence threshold.

4. The method of claim 1, wherein the user confidence score is calculated at least in part on a count of failed user verification.

5. The method of claim 1, wherein the user confidence score is calculated at least in part on a count of false rejection rate.

6. The method of claim 1, wherein the user confidence score is calculated at least in part on a password-less login frequency of the user.

7. The method of claim 1, wherein the user confidence score is calculated at least in part on a count of password authentication attempts during the grace period time.

8. The method of claim 1, the method further comprising the step of recalculating the confidence threshold using the user confidence score.

9. A method for calculating a user confidence score. the method comprising:
receiving a user False Rejection Rate (FRR) associated with the user;
comparing the user FRR to a population FRR to determine an initial user confidence score;
combining confidence factors with the initial user confidence score to create a user confidence; and
increasing a user confidence score associated with the user if the user confidence is greater than a previous user confidence.

10. The method of claim 9, wherein the step of combining confidence factors with the initial user confidence score to create a user confidence comprises combining a password-less login frequency of the user with the initial confidence score to create a user confidence.

11. The method of claim 9, wherein the step of combining confidence factors with the initial user confidence score to create a user confidence comprises combining a password authentication usage of the user with the initial confidence score to create a user confidence.

12. The method of claim 9, the method further comprising the step of decreasing the user confidence score associated with the user if the user confidence is less than a previous user confidence.
